(19) United States
(12) Patent Application Publication
(10) Pub. No.: US 2026/0213661 A1
(43) Pub. Date: Jul. 23, 2026

(54) ELECTRONIC CONTROL DEVICE

(71) Applicant: DENSO CORPORATION, Kariya-city (JP)

(72) Inventor: Kei SANADA, Kariya-city (JP)

(21) Appl. No.: 19/398,304

(22) Filed: Nov. 24, 2025

(30) Foreign Application Priority Data
Jan. 21, 2025 (JP) 2025-008739

(51) Int. Cl. H02M 3/158

(52) U.S. Cl. CPC H02M 3/1584

(57) ABSTRACT

A power supply control unit controls an on/off of a driver at a predetermined switching frequency so that a multi-phase power supply has a predetermined output voltage. A setting change unit 60 changes at least a voltage setting value based on a coupling coefficient of a coupled inductor. The setting change unit compares the coupling coefficient with a voltage change threshold, and when the coupling coefficient is equal to or less than a voltage change threshold, sets a voltage setting value to a low voltage value that is lower than the reference voltage value that is set when the coupling coefficient exceeds the voltage change threshold. The voltage change threshold is a value corresponding to a coupling coefficient that prevents an output voltage from exceeding an upper limit of a guaranteed operating voltage of a processor when a current consumption of the processor is at its lowest.

### CROSS REFERENCE TO RELATED APPLICATIONS

This application is based on Japanese Patent Application No. 2025-008739 filed on Jan. 21, 2025, the description of which is incorporated herein by reference.

### TECHNICAL FIELD

The present disclosure relates to an electronic control device.

### BACKGROUND

A coupled inductor for use in a multi-phase power supply is known.

### SUMMARY

An object of the present disclosure is to provide an electronic control device that can prevent the output voltage of a multi-phase power supply from exceeding the guaranteed operating voltage of a processor even when the coupling coefficient of the coupled inductor is small.

An electronic control device according to one aspect of the disclosure includes:
a multi-phase power supply having a plurality of phases each including a driver and an inductor, the inductor of each phase being configured by a coupled inductor;
a processor that receives power from the multi-phase power supply and operate; and
a control unit that controls an on/off of the driver at a predetermined switching frequency so that an output of the multi-phase power supply becomes a predetermined output voltage; and
a setting change unit that changes at least a voltage setting value, which is a setting value of the output voltage, among the setting values of the control unit, based on a coupling coefficient of the coupled inductor.

The setting change unit compares the coupling coefficient with a voltage change threshold, and when the coupling coefficient is equal to or less than a voltage change threshold, sets a voltage setting value to a low voltage value that is lower than the reference voltage value that is set when the coupling coefficient exceeds the voltage change threshold.

The voltage change threshold is a value corresponding to a coupling coefficient that prevents an output voltage from exceeding an upper limit of a guaranteed operating voltage of a processor when a current consumption of the processor is at its lowest.

### BRIEF DESCRIPTION OF DRAWINGS

FIG. 1 is a diagram showing an electronic control device according to a first embodiment;

FIG. 2 is a circuit diagram showing a multi-phase power supply;

FIG. 3 is a perspective view showing a coupled inductor;

FIG. 4 is a plan view showing a coupled inductor;

FIG. 5 is a plan view of the coupled inductor as viewed from the opposite side to the plan view of FIG. 4;

FIG. 6 is a plan view showing a core;

FIG. 7 is a perspective view showing a coil;

FIG. 8 is a diagram showing a reference example of a coupled inductor with a large gap;

FIG. 9 is a diagram showing a reference example of a coupled inductor with different gaps due to tilted assembly;

FIG. 10 is a diagram showing Ip and Vout waveforms when a coupled inductor with a small coupling coefficient is used;

FIG. 11 is a diagram showing an equivalent circuit of a coupled inductor;

FIG. 12 is a diagram showing a method for measuring self-inductance;

FIG. 13 is a diagram showing a method for measuring leakage inductance;

FIG. 14 is a flowchart showing a setting change process;

FIG. 15 is a diagram showing a load fluctuation voltage;

FIG. 16 is a diagram showing threshold values;

FIG. 17 is diagram showing Ip and Vout waveforms when changed to a low voltage value and a high frequency;

FIG. 18 is a flowchart showing a setting change process in an electronic control unit according to a second embodiment; and

FIG. 19 is a diagram illustrating threshold values.

### DETAILED DESCRIPTION

A coupled inductor for use in a multi-phase power supply is known. The disclosure of the prior art document (JP 2009-129937 A) is incorporated herein by reference as an explanation of the technical elements in this disclosure.

In the coupled inductor, an inductance is adjusted by, for example, a gap in a core material. The gap also has a significant effect on the degree of magnetic coupling between the coils, that is, the coupling coefficient. The gap varies due to manufacturing variations, which also cause variations in the coupling coefficient. When a coupled inductor with a small coupling coefficient is used, the magnetic flux cancellation effect is weakened, resulting in a high effective inductance. Therefore, the response to a sudden change in the current consumption of the processor becomes poor, and there is a risk that an output voltage of the multi-phase power supply will exceed the guaranteed operating voltage of the processor.

In the prior art document, a configuration is adopted in which a magnetic adhesive is disposed between two I-shaped magnetic cores, but this configuration cannot solve the above-mentioned problems. Further improvements are required in the electronic control device in the above respects and in other respects not mentioned above.

An object of the present disclosure is to provide an electronic control device that can prevent the output voltage of a multi-phase power supply from exceeding the guaranteed operating voltage of a processor even when the coupling coefficient of the coupled inductor is small.

An electronic control device according to one aspect of the disclosure includes:
a multi-phase power supply having a plurality of phases each including a driver and an inductor, the inductor of each phase being configured by a coupled inductor;
a processor that receives power from the multi-phase power supply and operate; and
a control unit that controls an on/off of the driver at a predetermined switching frequency so that an output of the multi-phase power supply becomes a predetermined output voltage; and
a setting change unit that changes at least a voltage setting value, which is a setting value of the output voltage, among the setting values of the control unit, based on a coupling coefficient of the coupled inductor.

The setting change unit compares the coupling coefficient with a voltage change threshold, and when the coupling coefficient is equal to or less than a voltage change threshold, sets a voltage setting value 321 to a low voltage value that is lower than the reference voltage value that is set when the coupling coefficient exceeds the voltage change threshold.

The voltage change threshold is a value corresponding to a coupling coefficient that prevents an output voltage from exceeding an upper limit of a guaranteed operating voltage of a processor when a current consumption of the processor is at its lowest.

When the coupling coefficient of the coupled inductor is small due to manufacturing variations or the like, the response will be poor as described above, and there is a risk that the output voltage of the multi-phase power supply will exceed the guaranteed operating voltage of the processor. In particular, when the current consumption of the processor suddenly decreases, the energy stored in the inductor directly leads to an overshoot in the output voltage, which has a large impact. According to the disclosed electronic control device, when the coupling coefficient is equal to or less than the voltage change threshold, it is determined that the coupling coefficient is one that may cause an overshoot, and the voltage setting value of the control unit is changed to a low voltage value. This results in a lower output voltage for the multi-phase power supply. Therefore, even if the coupling coefficient of the coupled inductor is small, the output voltage of the multi-phase power supply can be prevented from exceeding the guaranteed operating voltage of the processor.

The disclosed aspects in this specification adopt different technical solutions from each other in order to achieve their respective objectives. The objects, features, and advantages disclosed in this description will become apparent by referring to following detailed descriptions and accompanying drawings.

Hereinafter, multiple embodiments will be described with reference to the drawings. The same reference numerals are assigned to the corresponding elements in each embodiment, and thus, duplicate descriptions may be omitted. When only a part of the configuration is described in the respective embodiments, the configuration of the other embodiments described before may be applied to other parts of the configuration. Further, it is possible to not only combine configurations as specified in the description of the embodiments but also partially combine configurations of embodiments even though not specified herein as long as the combination does not cause difficulty.

### First Embodiment

First, an electronic control device according to the present embodiment will be described.

### Electronic Control Device

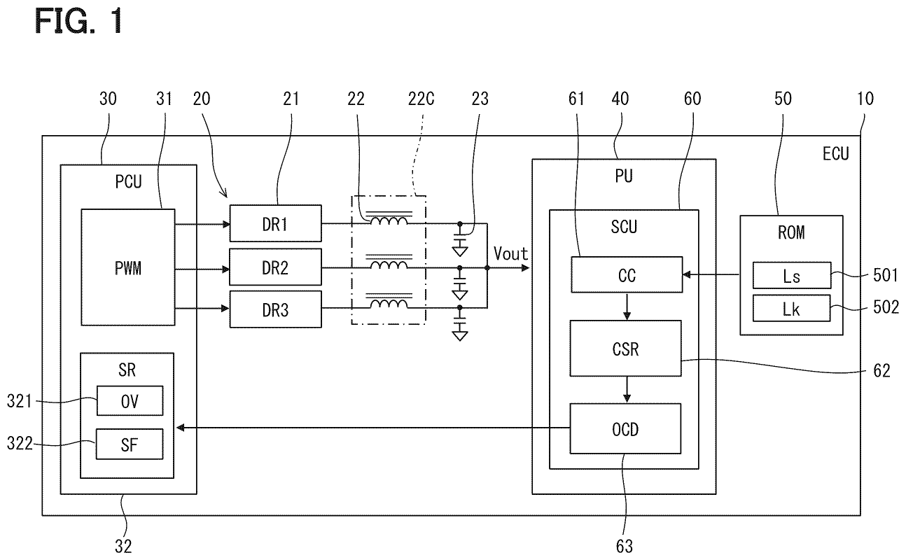

FIG. 1 shows an example of an electronic control device according to the present embodiment. The electronic control device 10 can be applied to, for example, a mobile object. Mobile objects include vehicles such as engine-driven vehicles, hybrid vehicles, and motor-driven vehicles, flying objects such as drones and eVTOLs, ships, construction machinery, and agricultural machinery. The eVTOL is an abbreviation for electric Vertical Take-Off and Landing aircraft. For example, when applied to a vehicle, the electronic control device 10 controls devices mounted on the vehicle.

The illustrated electronic control device 10 is an ECU mounted on the vehicle. ECU is an abbreviation of Electronic Control Unit. The electronic control device 10 may be, for example, an autonomous driving ECU or an ADAS ECU that performs control to assist drivers with driving operations. ADAS is an abbreviation for Advanced Driving Assistant System. For example, levels 3 to 5 as defined by the Society of Automotive Engineers (SAE International) correspond to automatic driving levels, while levels 1 to 2 correspond to driving assistance levels. The electronic control device 10 may be an infotainment ECU or a cockpit ECU. The cockpit ECU is an ECU that controls devices such as a meter device, a navigation device, and an air conditioning device. The electronic control device 10 may be, for example, an integrated ECU that integrates a plurality of control functions.

The electronic control device 10 includes a multi-phase power supply 20, a power supply control unit 30, a processor 40, a ROM 50, and a setting change unit 60. The electronic control device 10 may include a processor 40 as well as a load separate from the processor 40.

### Multiphase Power Supply

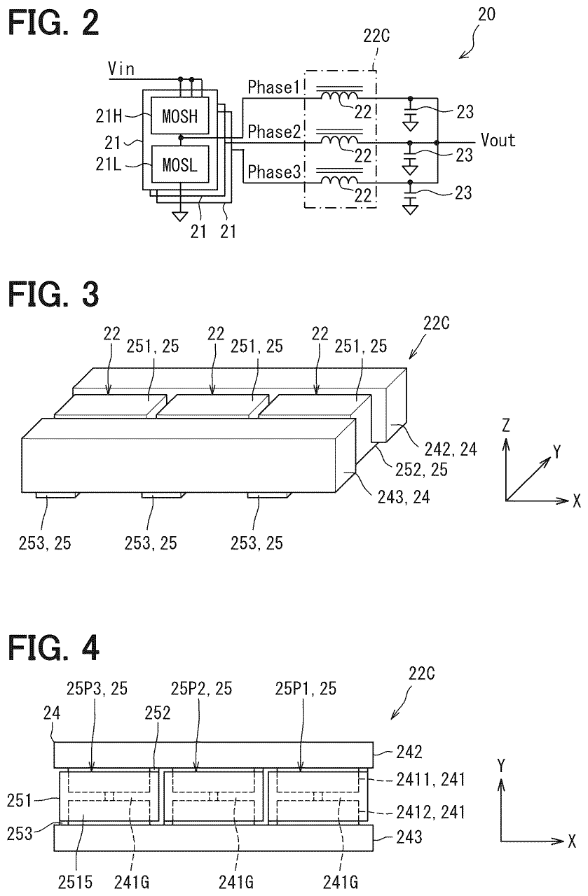

FIG. 2 is a circuit diagram showing a multi-phase power supply. For convenience, FIG. 2 shows a simplified view of some of the drivers. The multi-phase power supply 20 is a power supply circuit. The multi-phase power supply 20 steps down the input voltage to a predetermined voltage that can be supplied to a load such as the processor 40 and outputs the voltage. The multi-phase power supply 20 is a step-down DC-DC converter. The multi-phase power supply 20 steps down the input voltage Vin to a predetermined voltage (for example, around 1 V) and outputs it to the processor 40 as an output voltage Vout.

The electronic control device 10 may also include a primary power supply circuit (not shown) that, together with the multi-phase power supply 20, constitutes a power supply circuit. The primary power supply circuit is configured to be able to step down an input voltage to a predetermined voltage and output the voltage. The primary power supply circuit is a step-down DC-DC converter. The primary power supply circuit generates a constant voltage (for example, 5 V) lower than the power supply voltage (+B) based on power supplied from, for example, a battery mounted on the vehicle. In a configuration including a primary power supply circuit, the multi-phase power supply 20 is a secondary power supply circuit that receives the voltage generated by the primary power supply circuit as an input voltage Vin.

As shown in FIGS. 1 and 2, the multi-phase power supply 20 includes a plurality of drivers (DRs) 21, a coupled inductor 22C having a plurality of inductors 22, and a capacitor 23. The multi-phase power supply 20 has a plurality of phases, each including a driver 21 and an inductor 22. A phase may be referred to as a stage, a channel, etc. The number of phases is not particularly limited. The exemplary multi-phase power supply 20 has three phases. In FIG. 2, the three phases are shown as Phase 1, Phase 2, and Phase 3. In FIG. 1, the number added to the end of DR indicates which phase it constitutes. For example, DR1 is the driver 21 that constitutes Phase 1.

The exemplary driver 21 includes MOSFETs 21H and 21L. MOSFET is an abbreviation for Metal Oxide Semiconductor Field Effect Transistor. Instead of the MOSFETs 21H and 21L, other switching elements such as IGBTs may be used. The IGBT is an abbreviation of an insulated gate bipolar transistor. The MOSFETs 21H and 21L are connected in series between a power supply line to which an input voltage Vin is input and a ground (GND) line, with the MOSFET 21H on a high side and the MOSFET 21L on a low side. In FIGS. 1 and 2, the MOSFET 21H on the high side is indicated as MOSH, and the MOSFET 21L on the low side is indicated as MOSL. The exemplary driver 21 has a drive circuit (not shown) that turns on and off the MOSFETs 21H and 21L based on a PWM signal (described later).

One end of the inductor 22 is connected to the connection point (node) of the MOSFETs 21H and 21L. The other end of the inductor 22 is connected to an output line. The inductor 22 is provided individually for the driver 21. The driver 21 and the inductor 22 of each phase are connected in parallel with each other. The parallel connection allows the output current, and therefore the load current, from the multi-phase power supply 20 to be increased.

The capacitor 23 is connected to the output line. The positive terminal of the capacitor 23 is connected to the output line. The negative terminal of the capacitor 23 is connected to the ground. The capacitor 23 may be provided individually for each phase, or may be provided in common for a plurality of phases. In the exemplary multi-phase power supply 20, a capacitor 23 is provided for each phase.

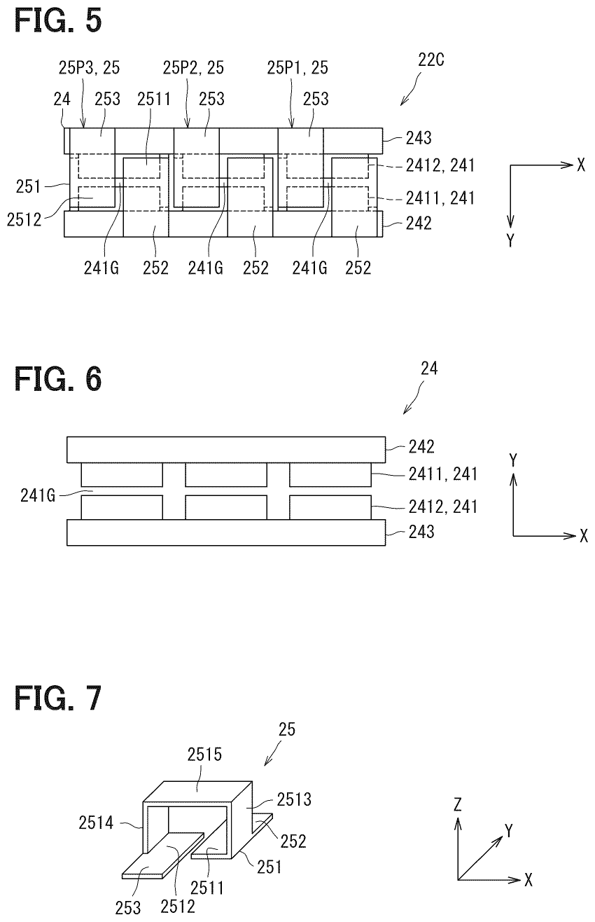

FIG. 3 is a perspective view showing an example of a coupled inductor. FIG. 4 is a plan view of the coupled inductor shown in FIG. 3 as seen from a top side. FIG. 5 is a plan view of the coupled inductor shown in FIG. 3 as viewed from a bottom side. FIG. 6 is a plan view showing a core. FIG. 7 is a perspective view showing a coil. A single coupled inductor 22C provides multiple inductors 22 that make up the multi-phase power supply 20.

In the following description, the direction in which a plurality of coils are arranged is referred to as the X direction. A direction perpendicular to the X direction, in which the two end cores are arranged, is referred to as the Y direction. A direction perpendicular to both the X direction and the Y direction is referred to as the Z direction. Unless otherwise specified, a shape viewed in a plane from the Z-direction, that is, a shape along an XY plane defined by the X-direction and Y-direction is referred to as a planar shape. The plan view from the Z direction may be simply referred to as a plan view.

As shown in FIGS. 3 to 5, the coupled inductor 22C includes a core 24 and a plurality of coils 25. One coil 25 constitutes one inductor 22. The plurality of coils 25 are arranged on one core 24, that is, a common core 24, and are magnetically coupled to one another. By using the coupled inductor 22C, magnetic fluxes between the phases can be cancelled out, and the effective inductance can be reduced.

The core 24 is formed using a magnetic material such as ferrite. The core 24 functions as a magnetic circuit. The core 24 has a plurality of central cores 241 and first and second end cores 242 and 243. The core 24 has a coil 25 inserted therethrough. The core 24 has the same number of central cores 241 as the number of phases. The central core 241 is provided individually for each coil 25. The coil 25 is wound around the central core 241. The central core 241 extends in the Y direction. The multiple central cores 241 are arranged in the X direction at predetermined intervals. The exemplary core 24 has three central cores 241. Each of the central cores 241 has a substantially rectangular parallelepiped shape. The three central cores 241 have the same shape.

The first and second end cores 242 and 243 are disposed opposite each other in the Y direction. The first and second end cores 242 and 243 sandwich the central core 241 therebetween. The first and second end cores 242 and 243 extend in the X direction, which is the direction in which the multiple central cores 241 are arranged. One ends of the plurality of central cores 241 are connected to the first end core 242, and the other ends of the plurality of central cores 241 are connected to the second end core 243. The first and second end cores 242 and 243 magnetically connect the plurality of central cores 241 together. The exemplary first and second end cores 242 and 243 have the same shape. The first and second end cores 242 and 243 are generally rectangular parallelepipeds with the X direction as the longitudinal direction.

Each of the central cores 241 is divided into a plurality of sections in the Y direction, which is the direction in which the first and second end cores 242 and 243 face each other. The exemplary central core 241 is divided at the center in the Y direction. The central core 241 includes a first central core 2411 and a second central core 2412. In the Y direction, the lengths of the first central core 2411 and the second central core 2412 are approximately equal. The first central core 2411 is connected to the first end core 242. The first central core 2411 extends from the surface of the first end core 242 facing the second end core 243 toward the second end core 243. The second central core 2412 is connected to the second end core 243. The second central core 2412 extends from the surface of the second end core 243 facing the end core 242 toward the first end core 242.

The core 24 has a gap 241G between the opposing surfaces of the first central core 2411 and the second central core 2412, where no magnetic member is disposed. The gap 241G is a gap (space) between the first and second central cores 2411 and 2412. An adhesive, for example, is placed in the gap 241G to fix the opposing first and second central cores 2411 and 2412 to each other. It should be noted that a division position is not limited to the center. For example, the division position may be set at a position shifted from the center.

The coil 25 is made of a metal material with good conductivity, such as copper. The coil 25 is formed by processing a metal plate material, rather than a metal wire material. The metal plate material is sometimes referred to as a metal frame. The plurality of coils 25 are made of the same material and have the same shape. The plurality of coils 25 have approximately the same inductance. The plurality of coils 25 are arranged in the X direction at predetermined intervals. The plurality of coils 25 are arranged in the same direction. The coil 25 is fixed to the core 24, for example, by adhesive. By placing the adjacent coils 25 closer to each other, the effect of canceling out the magnetic flux can be enhanced. That is, the effective inductance reduction effect can be improved.

The coil 25 is formed by bending a metal plate having a predetermined thickness. The coil 25 has a main body 251 and terminal portions 252 and 253. The main body 251 is a portion wound around the central core 241. The main body 251 is a portion that overlaps with the central core 241 in the plan view. The main body 251 has first and second bottom walls 2511 and 2512, first and second side walls 2513 and 2514, and a top wall 2515.

A thickness direction of the first and second bottom walls 2511 and 2512 is approximately parallel to the Z direction. The upper surface, which is one of the plate surfaces of the first and second bottom walls 2511 and 2512, faces the lower surface of the central core 241. The exemplary first and second bottom walls 2511 and 2512 have a generally rectangular shape in a plan view with the Y direction as the longitudinal direction. The upper surface of the first bottom wall 2511 faces the lower surface of the corresponding first and second central cores 2411, 2412. The upper surface of the second bottom wall 2512 faces the lower surface of the corresponding first and second central cores 2411, 2412. The first and second bottom walls 2511 and 2512 forming the same coil 25 are arranged at approximately the same position in the Z direction and are aligned in the X direction with a predetermined gap therebetween. The first and second bottom walls 2511 and 2512 face each other over the entire length in the Y direction.

The first side wall 2513 is continuous with the first bottom wall 2511. The first side wall 2513 extends in the Z direction from the first bottom wall 2511. The first side wall 2513 faces the side surface of the central core 241. The exemplary first side wall 2513 has a substantially rectangular shape when viewed in plan in the X direction. The first side wall 2513 has approximately the same length in the Y direction as the first bottom wall 2511. The first side wall 2513 is bent at an angle of approximately 90 degrees relative to the first bottom wall 2511. The thickness direction of the first side wall 2513 is approximately parallel to the X direction. The lower end of the first side wall 2513 is connected to the end of the first bottom wall 2511 opposite to the end facing the second bottom wall 2512.

Similarly, the second side wall 2514 is continuous with the second bottom wall 2512. The second side wall 2514 extends in the Z direction from the second bottom wall 2512. The second side wall 2514 faces the side surface of the central core 241 opposite to the surface that the first side wall 2513 faces. The exemplary second side wall 2514 has a substantially rectangular shape when viewed in plan in the X direction. The second side wall 2514 has approximately the same length in the Y direction as the second bottom wall 2512. The second side wall 2514 is bent at an angle of approximately 90 degrees relative to the second bottom wall 2512. The thickness direction of the second side wall 2514 is approximately parallel to the X direction. The lower end of the second side wall 2514 is connected to the end of the second bottom wall 2512 opposite to the end facing the first bottom wall 2511.

The top wall 2515 bridges the first and second side walls 2513 and 2514. The top wall 2515 extends in the X direction. One end of the top wall 2515 is continuous with the upper end of the first side wall 2513, and the other end is continuous with the upper end of the second side wall 2514. The top wall 2515 has the same length in the Y direction as the first and second side walls 2513 and 2514. In the plan view, the top wall 2515 encompasses the entire areas of the first and second side walls 2513 and 2514 and the first and second bottom walls 2511 and 2512.

The first and second bottom walls 2511 and 2512, the first and second side walls 2513 and 2514, and the top wall 2515 surround the central core 241. The first and second bottom walls 2511 and 2512, the first and second side walls 2513 and 2514, and the top wall 2515 are attached to and wound around the central core 241. The main body 251 is provided so as to overlap the gap 241G in the plan view.

The first and second terminal portions 252 and 253 are external connection terminals of the coil 25. The first and second terminal portions 252 and 253 are soldered to lands on a substrate (not shown), for example. The thickness direction of the first and second terminal portions 252 and 253 is approximately parallel to the Z direction. The first and second terminal portions 252 and 253 are connected to the main body 251.

The exemplary first and second terminal portions 252 and 253 have a generally rectangular shape in the plan view. The first terminal portion 252 is connected to the first bottom wall 2511 of the main body 251 and extends in the Y direction. The first terminal portion 252 extends in a straight line together with the first bottom wall 2511. The second terminal portion 253 is connected to the second bottom wall 2512 of the main body 251 and extends in the Y direction, in the opposite direction to the terminal portion 252. The terminal portion 253 extends in a straight line together with the second bottom wall 2512. The first and second terminal portions 252 and 253 connected to the same main body 251 are arranged offset in the Y direction. The first and second terminal portions 252 and 253 connected to the same main body 251 are arranged offset in the X direction.

The first terminal portion 252 is provided so that at least a portion thereof overlaps the first end core 242 within the range of manufacturing variations. The second terminal portion 253 is provided so that at least a portion thereof overlaps the second end core 243 within the range of manufacturing variations. The upper surface, which is one of the plate surfaces of the first terminal portion 252, faces the lower surface of the first end core 242. The upper surface of the second terminal portion 253 faces the lower surface of the second end core 243. The first and second terminal portions 252 and 253 may overlap a portion of the central core 241 in the plan view. A portion of the exemplary first terminal portion 252 overlaps a portion of the first central core 2411. A portion of the terminal portion 253 overlaps a portion of the central core 2412.

The coupled inductor 22C may include a cover (not shown) in addition to the core 24 and the plurality of coils 25. The cover is placed on the top surface of the core 24 so as to cover the core 24 and the plurality of coils 25. The cover is used, for example, to prevent foreign matter from adhering to the coupled inductor 22C. The cover is used for the purpose of preventing short circuits between the coils 25 due to, for example, conductive foreign matter. The cover is used, for example, to improve the adhesiveness during transportation when the coupled inductor 22C is mounted on a substrate. The material for the cover is not particularly limited as long as the above object can be achieved. For example, it may be made of a resin or a magnetic material.

Power Supply Control Unit:
The power supply control unit (PCU) 30 controls the multi-phase power supply 20. The power supply control unit 30 corresponds to a control unit that controls the on/off of the driver 21. The power supply control unit 30 includes a PWM control unit (PWM) 31 and a setting register (SR) 32. The PWM control unit 31 controls the on/off of the driver 21 at a predetermined switching frequency so that the output voltage Vout of the multi-phase power supply 20 becomes a predetermined voltage. The PWM control unit 31 controls the on/off of the driver 21 based on a voltage setting value (OV) 321, which is the setting value of the output voltage set in the setting register 32, and a frequency setting value (SF) 322, which is the setting value of the switching frequency. The PWM control unit 31 controls the on/off of the driver 21 at a frequency of a frequency setting value so that the output voltage Vout of the multi-phase power supply 20 becomes a voltage setting value.

When the power is turned on, the voltage setting value 321 of the setting register 32 is set to a reference voltage value, and the frequency setting value 322 is set to a reference frequency. The reference voltage value and the reference frequency are the initial setting values. The reference voltage value and reference frequency are set so that the output voltage Vout does not exceed the guaranteed operating voltage of the processor 40 even if the current consumption of the processor 40 suddenly changes when the gap 241G is at the center value of the manufacturing tolerance, for example.

The power supply control unit 30 performs voltage mode control by, for example, feedback of the output voltage Vout, and controls the operation of the driver 21, that is, the operation of the MOSFETs 21H and 21L. The power supply control unit 30 determines the pulse width (duty ratio) of a PWM signal, which is a control signal, based on the output voltage Vout, and controls the output voltage Vout of the multi-phase power supply 20. The power supply control unit 30 may execute current mode control instead of voltage mode control.

The power supply control unit 30 controls the plurality of drivers 21 in synchronization with each other so that the plurality of drivers 21 perform switching operations at different phases. By using a plurality of phases in this way, it is possible to increase the switching frequency artificially even if the switching frequencies of the plurality of drivers 21 are the same. This makes it possible to reduce the ripple component of the output voltage Vout and improve the responsiveness. The power supply control unit 30 switches the driver 21 to perform the switching operation, that is, the number of drive phases, depending on the load current. The power supply control unit 30 compares the load current with a threshold current, and increases and/or decreases the number of driving phases depending on the comparison result.

Processor:
A processor (PU) 40 is an example of a load that operates by receiving a supply of power (electric power) from the multi-phase power supply 20. The processor 40 is, for example, a CPU, a GPU, or the like. The CPU is an abbreviation of a Central Processing Unit. The GPU is an abbreviation of a Graphics Processing Unit. The electronic control device 10 may include only one processor 40 or multiple processors 30. The electronic control device 10 may include multiple types of processors 40. The processor 40 may be provided as a SoC, a chiplet, or a SiP. An SoC is a single semiconductor chip on which multiple components are mounted to realize the functions of a system or device. The SoC is an abbreviation of a system on chip. The SiP is an abbreviation for System in Package.

The processor 40 executes predetermined control processes by running a control program stored in memory. The memory is a non-transitory tangible storage medium that non-temporarily stores computer-readable programs, data, and the like.

The core voltage of the processor 40 is around 1 V (for example, less than 1 V), and the current consumption is several tens of amperes (A) or more (for example, 100 A or more). In order to accommodate such low voltages and large currents, the electronic control device 10 includes the multi-phase power supply 20 as a power supply circuit. The multi-phase power supply 20 steps down the input voltage to a voltage corresponding to the core voltage of the processor 40 and outputs the voltage. By using the multi-phase power supply 20, it is possible to accommodate the increased performance of the processor 40 that accompanies improvements in autonomous driving levels and the evolution of infotainment functions, and in particular to accommodate autonomous driving levels 3 and above.

In a high-performance processor 40, the current consumption fluctuates suddenly in response to the calculation processing, so many capacitors 23 are required so that a stable voltage can be supplied even when the load suddenly changes. By using the coupled inductor 22C, the effective inductance value can be reduced as described above, and therefore the responsiveness to sudden load changes is improved. This allows the capacitor 23 to be significantly reduced compared to a configuration using a normal single inductor. For example, the size of the multi-phase power supply 20, and therefore the size of the electronic control device 10, can be reduced.

### Gap and Magnetic Coupling

In the coupled inductor, as with a general coil, an inductance value is adjusted by the gap (gap) in the core formed within the coil. The gap in the core also contributes greatly to the degree of magnetic coupling between the coils.

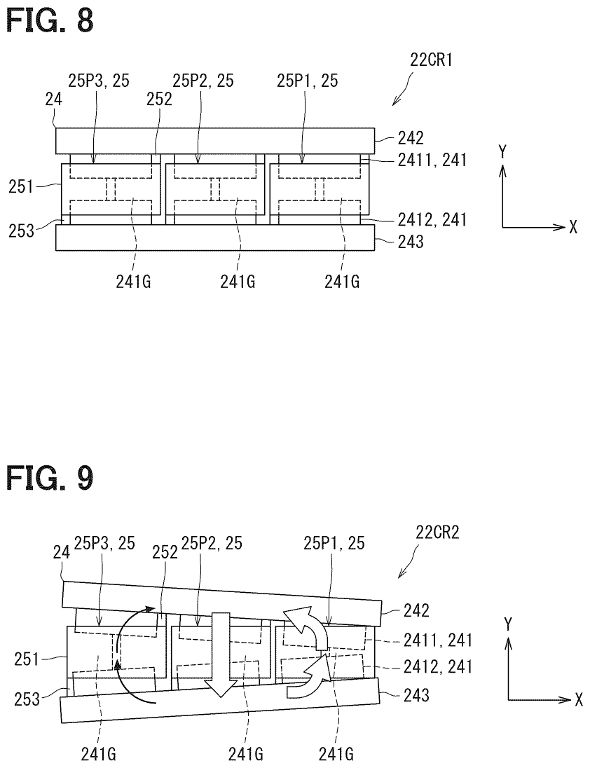

FIG. 8 is a diagram showing a reference example of a coupled inductor with a large gap. FIG. 9 is a diagram showing a reference example of a coupled inductor with different gaps due to tilted assembly. FIGS. 8 and 9 both illustrate a low coupling state. As a reference example, FIG. 8 shows a coupled inductor 22CR1, and FIG. 9 shows a coupled inductor 22CR2. The elements of the coupled inductors 22CR1 and 22CR2 are given the same reference numerals as the elements of the coupled inductor 22C described above.

In FIG. 8, the gap 241G between the first and second central cores 2411 and 2412 is uniformly large in all three central cores 241. The core material on the side of the first and second central 2411 and the first end core 242 and the core material on the side of the second central core 2412 and the second end core 243 are assembled together while being spaced apart in the Y direction. Such a configuration results in weak magnetic coupling. Since all the gaps 241G are uniformly large, the magnetic coupling is uniformly weakened.

In FIG. 9, the core material on the side of the first central core 2411 and the first end core 242 and the core material on the side of the second central core 2412 and the second end core 243 are assembled in an inclined state. Such a configuration results in weak magnetic coupling. The gap 241G varies among the plurality of central cores 241, but the influence of the decrease in magnetic coupling is more pronounced in areas where the gap 241G is particularly large. In FIG. 9, the flow of magnetic flux when a current is passed through the central coil 25P2 is indicated by solid arrows. In the example shown in FIG. 9, the magnetic coupling with the coil 25P1 is strong, and the magnetic coupling with the coil 25P3 is weak.

The low degree of coupling due to the large gap 241G or tilt, that is, the small coupling coefficient, is caused by, for example, manufacturing variations. Furthermore, there is a risk that this may occur after the fact due to the application of external force or deterioration over time. For example, there is a risk that the gap 241G may change later due to deterioration over time of the adhesive material placed in the gap 241G. The external force is, for example, stress due to vibration or thermal stress.

### Effect of a Small Coupling Coefficient

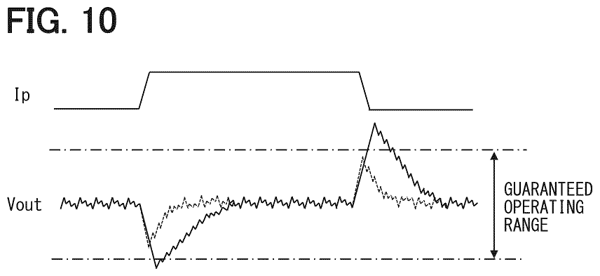

FIG. 10 is a diagram showing Ip and Vout waveforms when a coupled inductor with a small coupling coefficient is used. In FIG. 10, the waveform when the coupling coefficient is small is shown by a solid line, and the waveform when the coupling coefficient is larger than the solid line is shown by a broken line.

When a coupled inductor with a small coupling coefficient is used, the effect of canceling out the magnetic flux is weakened, resulting in a high effective inductance value. As a result, the power supply response deteriorates when the current consumption Ip of a load such as a processor suddenly changes. As shown in FIG. 10, the fluctuation of the output voltage Vout due to the sudden change in the consumption current Ip becomes large, and exceeds the guaranteed operating range of the load. In particular, when the consumption current Ip decreases suddenly, the energy stored in the inductor directly leads to an overshoot of the power supply voltage, which has a large effect.

Furthermore, in the coupled inductors, magnetic fluxes cancel each other out, preventing magnetic saturation. However, when the coupling coefficient is small, the effect of canceling out the magnetic flux weakens, leading to magnetic saturation. A magnetically saturated coil has a significantly reduced inductance value, which may prevent normal switching operation.

### ROM

The ROM 50 stores data for the setting change unit 60 to execute the setting value change process based on the coupling coefficient. The ROM 50 is an example of a non-volatile memory that stores data. The ROM is an abbreviation for Read Only Memory. The exemplified ROM 50 stores, as data, an Ls measurement value (Ls) 501 which is a measurement value of the self-inductance Ls, and an Lk measurement value (Lk) 502 which is a measurement value of the leakage inductance Lk.

By storing the Ls measurement value 501 and the Lk measurement value 502 in the ROM 50, the electronic control device 10 does not need to be provided with a function for measuring the self-inductance Ls and the leakage inductance Lk. This allows, for example, the electronic control device 10 to be simplified.

The control program for the processor 40 to execute the control may be stored in the ROM 50 or in a memory separate from the ROM 50.

### Self-Inductance, Leakage Inductance, and Coupling Coefficient

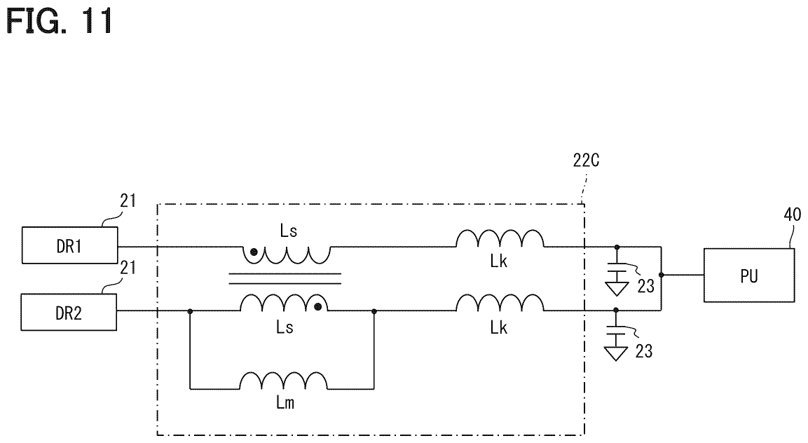

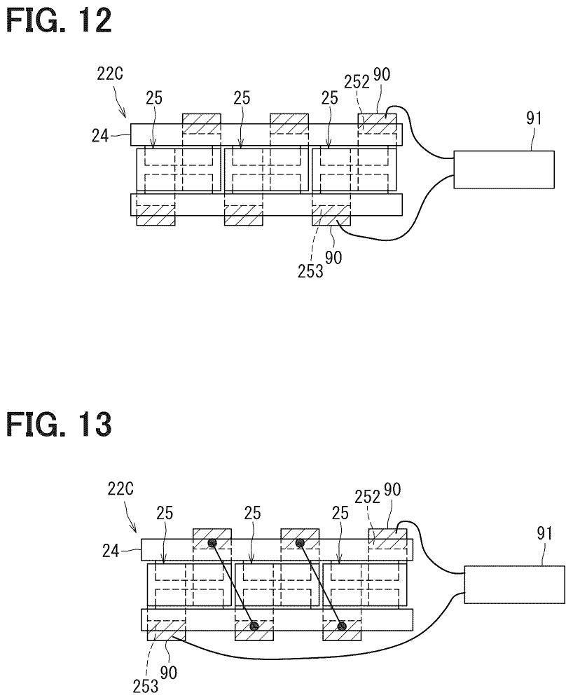

FIG. 11 is a diagram showing an equivalent circuit of a coupled inductor. For convenience, FIG. 11 shows an example in which the number of phases is two. FIG.
12 is a diagram showing an example of a method for measuring self-inductance. FIG. 13 is a diagram showing an example of a method for measuring leakage inductance. For convenience, only the lands of the measurement substrate are shown in FIGS. 12 and 13.

A relationship of Equation 1 holds between the mutual inductance Lm, the leakage inductance Lk, and the coupling coefficient ρ. The coupling coefficient ρ is calculated by dividing the mutual inductance Lm by the leakage inductance Lk. The coupling coefficient ρ is expressed as a ratio of the mutual inductance Lm to the leakage inductance Lk.

$$ρ = Lm / Lk \qquad ( Equation 1 )$$

A relationship of Equation 2 holds between the mutual inductance Lm, the self-inductance Ls, and the leakage inductance Lk. The mutual inductance Lm is obtained by subtracting the leakage inductance Lk from the self-inductance Ls.

$$Lm = Ls - Lk \qquad ( Equation 2 )$$

Based on the equations 1 and 2, the relationship of Equation 3 holds between the coupling coefficient ρ, the self-inductance Ls, and the leakage inductance Lk. The coupling coefficient ρ is calculated by subtracting the leakage inductance Lk from the self-inductance Ls and dividing the result by the leakage inductance Lk.

$$ρ = ( Ls - Lk ) / Lk \qquad ( Equation 3 )$$

When the measured values of Ls and Lk are available, the coupling coefficient ρ can be calculated as shown in Equation 3. However, it is difficult to measure the self-inductance Ls and the leakage inductance Lk when they are mounted in the electronic control device. The self-inductance Ls and the leakage inductance Lk are generally measured with the coupled inductor 22C alone connected to a dedicated measurement board. Therefore, it is practical to write the self-inductance Ls and leakage inductance Lk measured for each component in advance to a non-volatile memory such as the ROM 50, and then read out the values when the set value change process is executed. Instead of the Ls measurement value and the Lk measurement value, a coupling coefficient ρ calculated based on the Ls measurement value and the Lk measurement value may be written in the ROM 50.

The Ls measurement value is an inductance value measured when the multiple coils 25 are electrically separated, that is, when each coil 25 is open, as shown in FIG. 12. The first and second terminal portions 252 and 253 of the coil 25 are joined to the corresponding lands 90 of the measurement board, and the terminals of an LCR meter 91 are connected to the lands 90 corresponding to the first and second terminal portions 252 and 253 of one of the coils 25 to measure the inductance value.

As shown in FIG. 13, the Lk measurement value is a value obtained by dividing the inductance value measured with all the coils 25 connected in series by the number of phases. The first and second terminal portions 252, 253 are joined to the land 90, and the terminals of an LCR meter 91 are connected to the land 90 corresponding to the first terminal portion 252 on one end side of the multiple coils 25 connected in series and the land 90 corresponding to the second terminal portion 253 on the other end side, to measure the inductance value.

The degree of coupling of the coupled inductor 22C can be determined by using the coupling coefficient ρ calculated from the Ls and Lk measurement values. By using the Ls and Lk measurement values, it is possible to calculate an accurate coupling coefficient based on manufacturing variations in the actual coupled inductor 22C.

### Setting Change Unit

The setting change unit (SCU) 60 determines the operating specifications of the multi-phase power supply 20 based on the coupling coefficient of the coupled inductor 22C, and changes the setting value of the setting register 32. As an operational specification, the setting change unit 60 may change at least the output voltage, or may change the switching frequency in addition to the output voltage.

The setting change unit 60 may be provided separately from the driver 21 of the multi-phase power supply, the power supply control unit 30, the processor 40, and the ROM 50. The setting change unit 60 may be provided separately from the other elements that configure the electronic control device 10. The setting change unit 60 may be implemented discretely. The exemplary setting change unit 60 is provided within the processor 40. The setting change unit 60 is provided integrally with the processor 40. The setting change unit 60 includes a coupling coefficient calculation portion (CC) 61, a storage register (CSR) 62, and an operation specification determination portion (OCD) 63.

The coupling coefficient calculation portion 61 reads out the Ls measurement value 501 and the Lk measurement value 502 stored in the ROM 50, and calculates the coupling coefficient ρ based on the relationship of Equation 3 above. The storage register 62 stores the calculated coupling coefficient ρ. The storage register 62 holds the calculated coupling coefficient ρ. The operation specification determination portion 63 determines the operation specification based on the coupling coefficient ρ set in the storage register 62 and outputs it to the setting register 32 of the power supply control unit 30. The exemplary operational specification determination portion 63 compares the coupling coefficient ρ with a threshold value, which will be described later, and changes the operational specification, that is, the setting value of the setting register 32, when a predetermined condition is satisfied. The operational specification determination portion 63 may have a function to restrict the processing of the processor 40.

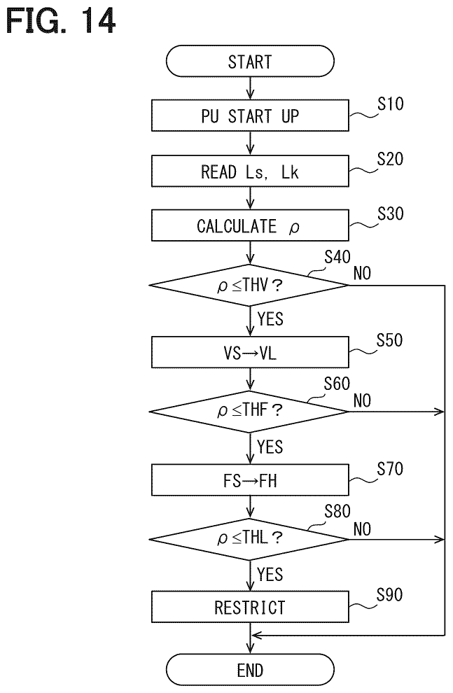

FIG. 14 is a flowchart showing an example of the setting change process. When the multi-phase power supply 20 is started up, the processor 40 including the setting change unit 60 executes a setting change process. The processor 40 including the setting change unit 60 performs the following process every time the multi-phase power supply 20 is started up. At start-up, the reference voltage value VS is set as the voltage setting value 321 in the setting register 32, and the reference frequency FS is set as the frequency setting value 322. The multi-phase power supply 20 starts up with the reference voltage value VS and the reference frequency FS, which are initial set values (defaults) at the time of start-up.

The processor (PU) 40 receives power supply from the multi-phase power supply 20 and starts up (step S10). After the processor 40 is started up, the setting change unit 60 reads the Ls measurement value 501 and the Lk measurement value 502 from the ROM 50 (step S20).

Next, the setting change unit 60 calculates the coupling coefficient ρ (step S30). The setting change unit 60 calculates the coupling coefficient ρ from the Ls measurement value 501 and the Lk measurement value 502 based on the relationship of the above-mentioned equation 3. The start-up process of the processor 40 generally involves reading the OS and application data from the nonvolatile memory. Therefore, when the setting change unit 60 is provided in the processor 40, the Ls measurement value 501 and the Lk measurement value 502 can be read at the same time as reading the OS or the like, thereby simplifying the start-up control. The OS is an abbreviation for Operating System.

As described above, the coupling coefficient ρ may be calculated in advance and stored in the ROM 50. In this case, instead of the processing of steps S20 and S30, the coupling coefficient ρ may be read from the ROM 50. When the coupling coefficient ρ is stored in advance, it becomes unnecessary to calculate the coupling coefficient ρ, and the time required for the setting change process can be reduced.

Next, the setting change unit 60 compares the coupling coefficient ρ with the threshold value THV, and determines whether the coupling coefficient ρ is equal to or smaller than the threshold value THV (step S40). The threshold value THV is a threshold value for determining whether or not the voltage setting value 321 needs to be changed, that is, a voltage change threshold value. The threshold value THV is set to a value corresponding to a coupling coefficient such that the output voltage Vout does not exceed the upper limit UL of the guaranteed operating voltage of the processor 40 when the current consumption Ip of the processor 40 is at its lowest. The threshold value THV is a value corresponding to the coupling coefficient when the output voltage Vout coincides with the upper limit of the guaranteed operating voltage, for example, in a state where the reference voltage value VS and the reference frequency FS are set.

When the coupling coefficient ρ exceeds the threshold value THV, the setting change unit 60 ends the series of processes. When the coupling coefficient ρ is equal to or smaller than the threshold value THV, the setting change unit 60 executes a process of changing the voltage setting value 321 of the setting register 32 from the reference voltage value VS to the low voltage value VL (step S50). As a result, the low voltage value VL is set in the setting register 32, and the output voltage of the multi-phase power supply 20 is controlled to be the low voltage value VL. The low voltage value VL is a value obtained by shifting the reference voltage value VS to the negative side by a predetermined amount, and is defined in advance.

When the coupling coefficient is small, the output voltage will fluctuate more when the processor processing suddenly changes. Since the influence of overshoot is particularly large when the load suddenly changes, in step S40 it is determined whether the coupling coefficient is such that the overshoot voltage can exceed the upper limit value UL. When the coupling coefficient ρ is equal to or less than the threshold value THV, the amount of overshoot is highly dependent on the inductance, and a significant improvement in response cannot be expected even if the switching frequency is increased, so the overshoot is suppressed by lowering the output voltage.

Next, the setting change unit 60 compares the coupling coefficient ρ with the threshold value THF, and determines whether the coupling coefficient ρ is equal to or less than the threshold value THF (step S60). The threshold value THF is a threshold value for determining whether or not the frequency setting value 322 needs to be changed, that is, a frequency change threshold value. The threshold value THF has a lower value than the threshold value THV. The exemplary threshold THF is set to a value equivalent to a coupling coefficient such that the output voltage Vout does not fall below the lower limit LL of the guaranteed operating voltage of the processor 40 when the current consumption Ip of the processor 40 increases the most when the low voltage value VL is set. The threshold value THF is a value corresponding to the coupling coefficient when the output voltage Vout coincides with the lower limit of the guaranteed operating voltage, for example, in a state where the low voltage value VL and the reference frequency FS are set.

When the coupling coefficient ρ exceeds the threshold value THF, the setting change unit 60 ends the series of processes. When the coupling coefficient ρ is equal to or less than the threshold value THF, the setting change unit 60 executes a process of changing the frequency setting value 322 of the setting register 32 from the reference frequency FS to a predetermined high frequency FH that is higher than the reference frequency FS (step S70). As a result, the high frequency FH is set in the setting register 32, and the driver 21 is controlled to be turned on and off at the high frequency FH.

By lowering the output voltage, it is possible to suppress overshoot, but as a trade-off, when the processor load suddenly increases, the drop in power supply voltage (undershoot) becomes larger. Therefore, when the coupling coefficient is even smaller than the threshold value THV, there is a risk that the output voltage Vout becomes lower than the lower limit LL of the guaranteed operating voltage when the processor load suddenly increases. When the coupling coefficient ρ is equal to or less than the threshold value THF, the switching frequency is increased to increase the speed at which the charge is charged, thereby suppressing undershoot.

Next, the setting change unit 60 compares the coupling coefficient ρ with the threshold value THL, and determines whether the THL (step S80). The threshold value THL is a threshold value for determining whether or not the operation of the processor 40 needs to be restricted, that is, a restriction determination threshold value. The threshold value THL has a lower value than the threshold value THV and the threshold value THF. The exemplary threshold THL is set to a value corresponding to a coupling coefficient such that the output voltage Vout does not exceed the guaranteed operating voltage of the processor 40 when the current consumption Ip increases or decreases the most when the low voltage value VL and the high frequency FH are set. The threshold value THL is a value corresponding to the coupling coefficient when the output voltage Vout coincides with the upper or lower limit of the guaranteed operating voltage when, for example, the low voltage value VL and the high frequency FH are set.

When the coupling coefficient ρ exceeds the threshold value THL, the setting change unit 60 ends the series of processes. When the coupling coefficient ρ is equal to or less than the threshold value THL, the setting change unit 60 executes a process of restricting the operation of the processor 40 (step S90), and ends the series of processes. The setting change unit 60 prohibits the processor 40 from executing high-load processing, for example. In other words, the processes that the processor 40 can execute are limited to medium load process and low load process.

When the coupling coefficient is smaller than the threshold value THF, the influence of the power supply voltage fluctuations when the processor workload changes suddenly cannot be suppressed by adjusting the output voltage or the switching frequency. When the coupling coefficient is equal to or less than the threshold value THL, the processor 40 is prohibited from executing high-load processing, thereby reducing the load fluctuation range.

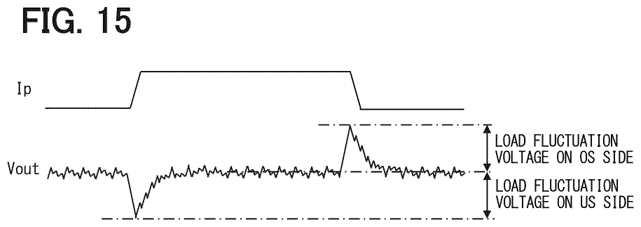

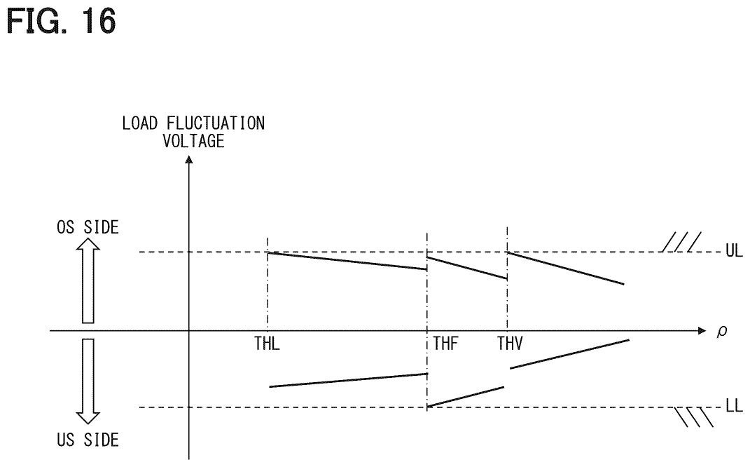

FIG. 15 is a diagram showing a voltage due to load fluctuation. FIG. 16 is a diagram showing threshold values. In FIG. 16, the horizontal axis represents the coupling coefficient ρ, and the vertical axis represents the voltage due to load fluctuation.

As shown in FIG. 15, the side of the load fluctuation voltage that is higher than the reference is defined as the overshoot (OS) side, and the side of the load fluctuation voltage that is lower than the reference is defined as the undershoot (US) side. As shown in FIG. 16, the threshold value THF is smaller than the threshold value THV, and the threshold value THL is smaller than the threshold value THF. The threshold value THV is the largest and the threshold value THL is the smallest. When the coupling coefficient ρ is equal to or less than the threshold value THV, the load fluctuation voltage shifts to the negative side due to switching to the low voltage value VL. This makes it possible to suppress overshoot. When the coupling coefficient ρ is equal to or less than the threshold value THF, load fluctuation voltage is suppressed by switching to the high frequency FH, and the change (slope) of the load fluctuation voltage relative to the coupling coefficient ρ, that is, the influence of the coupling coefficient ρ, becomes smaller. This makes it possible to suppress undershoot. When the coupling coefficient ρ is equal to or less than the threshold THL, high-load processing of the processor 40 is prohibited.

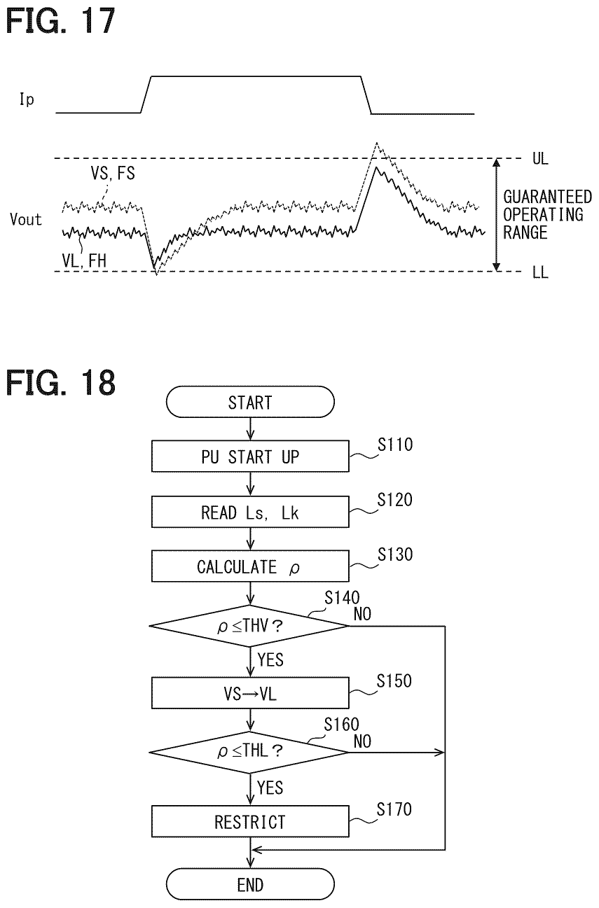

FIG. 17 is diagram showing Ip and Vout waveforms when changed to a low voltage value and a high frequency. In FIG. 17, the waveform after the change to the low voltage value VL and the high frequency FH is shown by a solid line. In FIG. 17, the waveforms before the change, that is, when the reference voltage value VS and the reference frequency FS are set, are shown by dashed lines. As shown in FIG. 17, by changing to the low voltage value VL, the output voltage line is lowered compared to before the change, and the point reached during overshoot can be reduced. Furthermore, by changing to the high frequency FH, the responsiveness of the multi-phase power supply 20 is improved, and the amount of drop during undershoot can be reduced.

Overview of First Embodiment

The electronic control device 10 of the present embodiment includes a multi-phase power supply 20 having a driver 21 and a coupled inductor 22C, a power supply control unit 30, a processor 40, and a setting change unit 60. The power supply control unit 30 controls the on/off of the driver 21 at a predetermined switching frequency so that the output of the multi-phase power supply 20 becomes a predetermined output voltage. The setting change unit 60 changes at least the voltage setting value 321, which is the setting value of the output voltage, among the setting values of the power supply control unit 30, based on the coupling coefficient ρ of the coupled inductor 22C. The setting change unit 60 compares the coupling coefficient ρ with the voltage change threshold THV, and when the coupling coefficient ρ is equal to or less than the voltage change threshold THV, sets the voltage setting value 321 to a low voltage value VL that is lower than the reference voltage value VS that is set when the coupling coefficient ρ exceeds the voltage change threshold THV. The voltage change threshold THV is a value corresponding to a coupling coefficient that prevents the output voltage Vout from exceeding the upper limit UL of the guaranteed operating voltage (guaranteed operating range) of the processor 40 when the consumption current Ip of the processor 40 is at its lowest.

When the coupling coefficient of the coupled inductor is small due to manufacturing variations or the like, the response will be poor as described above, and there is a risk that the output voltage of the multi-phase power supply will exceed the guaranteed operating voltage of the processor. In particular, when the current consumption of the processor suddenly decreases, the energy stored in the inductor directly leads to an overshoot in the output voltage, which has a large impact. In order to prevent the guaranteed operating voltage from being exceeded, it is effective to reduce the processing load on the processor so that the fluctuation range of current consumption becomes smaller. However, reducing the processing load on the processor places restrictions on the control of applications that are executed, and the processor's processing capabilities cannot be maximized.

According to the electronic control device 10 of the present embodiment, when the coupling coefficient ρ is equal to or less than the voltage change threshold THV, it is determined to be a coupling coefficient that may cause overshoot, and the voltage setting value 321 of the power supply control unit 30 is changed to the low voltage value VL. This causes the output voltage Vout of the multi-phase power supply 20 to decrease. Therefore, even if the coupling coefficient ρ of the coupled inductor 22C is small, the output voltage Vout of the multi-phase power supply 20 can be prevented from exceeding the guaranteed operating voltage of the processor 40. Since the processing load of the processor 40 is not reduced as a first measure to prevent the guaranteed operating voltage from being exceeded, it is possible to prevent restrictions on application control to be executed. By using the threshold value THV defined as above, it becomes possible to suppress the influence of a small coupling coefficient ρ due to manufacturing variations or the like simply by adjusting the output voltage Vout.

As illustrated, the setting change unit 60 may change the voltage setting value 321 and the frequency setting value 322 as the setting values of the power supply control unit 30. The setting change unit 60 may compare the coupling coefficient ρ with a frequency change threshold THF that is lower than the voltage change threshold THV. When the coupling coefficient ρ is equal to or less than the frequency change threshold THF, the setting change unit 60 may set the voltage setting value 321 to a low voltage value VL, and may set the frequency setting value 322 to a high frequency FH that is higher than the reference frequency FS that is set when the coupling coefficient ρ exceeds the frequency change threshold THF.

According to this configuration, in a range that cannot be addressed by adjusting only the output voltage Vout, by also adjusting the switching frequency, it is possible to prevent the guaranteed operating voltage of the processor 40 from being exceeded even if the coupling coefficient ρ is small. It is possible to suppress the undershoot associated with the adjustment of the output voltage Vout.

As illustrated, the setting change unit 60 may compare the coupling coefficient ρ with a restriction determination threshold THL that is lower than the frequency change threshold THF. When the coupling coefficient ρ is equal to or less than the restriction determination threshold THL, the setting change unit 60 may restrict the operation of the processor 40 so that the fluctuation range of the current consumption of the processor 40 is smaller than when the low voltage value VL and the high frequency FH are set. For example, even if the influence of manufacturing variations cannot be suppressed by adjusting the output voltage Vout and the switching frequency, the output voltage Vout of the multi-phase power supply 20 can be prevented from exceeding the guaranteed operating voltage of the processor 40.

As shown in the example, the frequency change threshold THF may be set to a value corresponding to a coupling coefficient such that the output voltage Vout does not fall below the lower limit LL of the guaranteed operating voltage of the processor 40 when the current consumption Ip of the processor 40 increases the most when the low voltage value VL is set. By using the threshold value THF defined in this way and the threshold value THV defined above, it is possible to appropriately set the range that can be suppressed by adjusting the output voltage Vout and the switching frequency.

As shown in the example, the restriction determination threshold THL may be set to a value corresponding to a coupling coefficient such that the output voltage Vout does not exceed the guaranteed operating voltage of the processor 40 when the current consumption Ip of the processor 40 increases or decreases the most when the low voltage value VL and high frequency FH are in a state. By using the threshold value THL defined in this way, it is possible to appropriately determine whether or not it is necessary to limit the processing load on the processor 40.

As illustrated, the setting change unit 60 may be provided within the processor 40. By providing the setting change unit 60 within the processor 40, the electronic control device 10 can be simplified compared to when the setting change unit 60 is configured as a discrete unit. The processor 40 operates by receiving power from the multi-phase power supply 20, and therefore, by providing the setting change unit 60 within the processor 40, the various processes described above can be executed.

### Modification Example

The restriction determination threshold THL may not be used as the threshold to be compared with the coupling coefficient ρ. The setting change unit 60 may omit the processes of steps S80 and S90 illustrated in FIG. 14 and execute the processes of steps S10 to S70.

### Second Embodiment

A second embodiment is a modification of the preceding embodiment as a basic configuration and may incorporate description of the precedent embodiments. In the previous embodiment, the frequency change threshold THF is used as the threshold to be compared with the coupling coefficient ρ. Alternatively, the frequency change threshold THF may not be used.

FIG. 18 is a flowchart showing an example of processing executed by a processor including a setting change unit, that is, setting change processing, in the electronic control device according to the present embodiment. As in the previous embodiment, when the multi-phase power supply 20 is started up, the processor 40 including the setting change unit 60 executes the setting change process. The multi-phase power supply 20 starts up with a reference voltage value VS and a reference frequency FS, which are initial values at the time of start-up.

The processes of steps S110, S120, S130, S140, and S150 are substantially the same as the processes of steps S10, S20, S30, S40, and S50 described in the previous embodiment. As described in the previous embodiment, the coupling coefficient ρ may be calculated in advance and stored in the ROM 50. In this case, instead of the processes of steps S120 and S130, the coupling coefficient ρ may be read from the ROM 50.

After changing the voltage setting value 321 from the reference voltage value VS to the low voltage value VL in step S150, the setting change unit 60 then compares the coupling coefficient ρ with the threshold value THL and determines whether the coupling coefficient ρ is equal to or less than the threshold value THL (step S160). The threshold value THL is a restriction determination threshold value and has a value lower than the threshold value THV. The exemplary threshold THL is set to a value corresponding to a coupling coefficient such that the output voltage Vout does not exceed the guaranteed operating voltage of the processor 40 when the current consumption Ip increases or decreases the most when the low voltage value VL is set. The threshold value THL is a value corresponding to the coupling coefficient when the output voltage Vout coincides with the upper or lower limit of the guaranteed operating voltage, for example, when the low voltage value VL and the reference frequency FS are set.

When the coupling coefficient ρ exceeds the threshold value THL, the setting change unit 60 ends the series of processes. When the coupling coefficient ρ is equal to or less than the threshold value THL, the setting change unit 60 executes a process of restricting the operation of the processor 40 (step S170), and ends the series of processes. The setting change unit 60 prohibits the processor 40 from executing high-load processing, for example. In other words, the processes that the processor 40 can execute are limited to medium load process and low load process.

As described above, the setting change unit 60 does not use the frequency change threshold THF for comparison with the coupling coefficient ρ. The setting change unit 60 has a voltage change threshold THV and a restriction determination threshold THL as thresholds used for comparison with the coupling coefficient ρ.

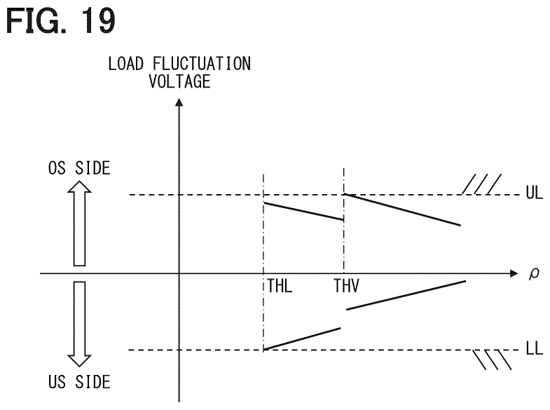

FIG. 19 is a diagram showing threshold values. FIG. 19 corresponds to FIG. 16. As shown in FIG. 19, the threshold value THL is smaller than the threshold value THV. The threshold value THV is the largest and the threshold value THL is the smallest. When the coupling coefficient ρ is equal to or less than the threshold value THV, the load fluctuation voltage shifts to the negative side due to switching to the low voltage value VL. This makes it possible to suppress overshoot. When the coupling coefficient ρ is equal to or less than the threshold THL, high-load processing of the processor 40 is prohibited. The other configurations are the same as those described in the previous embodiment.

### Overview of Second Embodiment

As illustrated, the setting change unit 60 may compare the coupling coefficient ρ with a restriction determination threshold THL that is lower than the voltage change threshold THV. When the coupling coefficient ρ is equal to or less than the restriction determination threshold THL, the setting change unit 60 may restrict the operation of the processor 40 so that the fluctuation range of the current consumption of the processor 40 is smaller than when the low voltage value VL is set. This makes it possible to prevent the output voltage Vout of the multi-phase power supply 20 from exceeding the guaranteed operating voltage of the processor 40 in a range that cannot be addressed by adjusting the output voltage Vout alone.

As shown in the example, the restriction determination threshold THL may be set to a value equivalent to a coupling coefficient such that the output voltage Vout does not exceed the guaranteed operating voltage of the processor 40 when the current consumption Ip of the processor 40 increases or decreases the most when the low voltage value VL is set. By using the threshold value THL defined in this way, it is possible to appropriately determine whether or not it is necessary to limit the processing load on the processor 40.

### Modification Example

The restriction determination threshold THL may not be used as the threshold to be compared with the coupling coefficient ρ. The setting change unit 60 may omit FIG. 18 and execute the processes of steps S110 to S150.

### Other Embodiments

The disclosure in this specification and drawings is not limited to the exemplified embodiments. The disclosure encompasses the illustrated embodiments and modifications by those skilled in the art based thereon. For example, the disclosure is not limited to the combinations of components and/or elements shown in the embodiments. The disclosure may be implemented in various combinations. The disclosure may have additional portions that may be added to the embodiments. The disclosure encompasses omission of components and/or elements of the embodiments. The disclosure encompasses the replacement or combination of components and/or elements between one embodiment and another. The disclosed technical scope is not limited to the description of the embodiments. Some aspects of the disclosed technical scope are indicated by the recitations of the claims, and should further be construed to include all modifications within the meaning and scope equivalent to those recitations.

The disclosure in the specification, the drawings and the like are not limited by the description of the claims. The disclosures in the specification, the drawings, and the like encompass the technical ideas described in the claims, and further extend to a wider variety of technical ideas than those in the claims. Thus, various technical ideas can be extracted from the disclosure of the specification, the drawings and the like without being limited to the description of the present disclosure.

When an element or a layer is described as “disposed above” or “connected”, the element or the layer may be directly disposed above or connected to another element or another layer, or an intervening element or an intervening layer may be present therebetween. In contrast, when an element or a layer is described as “disposed directly above” or “directly connected”, an intervening element or an intervening layer is not present. Other terms used to describe the relationships between elements (for example, “between” vs. “directly between”, and “adjacent” vs. “directly adjacent”) should be interpreted similarly. As used herein, the term “and/or” includes any combination and all combinations relating to one or more of the related listed items. For example, the term A and/or B includes only A, only B, or both A and B. The description of A and/or B means at least one of A and B.

Spatial relative terms “inside”, “outside”, “back”, “bottom”, “low”, “top”, “high”, etc. are used herein to facilitate the description that describes relationships between one element or feature and another element or feature. Spatial relative terms can be intended to include different orientations of a device in use or operation, in addition to the orientations depicted in the drawings. For example, when the device in the figure is flipped over, an element described as “below” or “directly below” another element or feature is directed “above” the other element or feature. Therefore, the term “below” can include both above and below. The device may be oriented in another direction (rotated 90 degrees or in any other direction) and the spatially relative terms used herein are interpreted accordingly.

What is claimed is:

1. An electronic control device, comprising:
a processor with a memory storing computer program code executable by the processor, the processor configured to cause the electronic control device to:
receive power from a multi-phase power supply having a plurality of phases each including a driver and an inductor with the inductor of each phase configured as a coupled inductor, and operate;
control an on/off of the driver at a predetermined switching frequency so that an output of the multi-phase power supply becomes a predetermined output voltage;
change at least a voltage setting value, which is a setting value of output voltage, among setting values, based on a coupling coefficient of the coupled inductor; and
compare the coupling coefficient with a voltage change threshold, and when the coupling coefficient is equal to or less than the voltage change threshold, sets the voltage setting value to a low voltage value that is lower than a reference voltage value that is set when the coupling coefficient exceeds the voltage change threshold, wherein
the voltage change threshold is a value corresponding to the coupling coefficient that prevents the output voltage from exceeding an upper limit of a guaranteed operating voltage of the processor when a current consumption of the processor decreases the most.

2. The electronic control device according to claim 1, wherein
the processor is further configured to compare the coupling coefficient with a restriction determination threshold that is lower than the voltage change threshold, and when the coupling coefficient is equal to or less than the restriction determination threshold, limit an operation of the processor so that a fluctuation range of the current consumption of the processor is smaller than when the low voltage value is set.

3. The electronic control device according to claim 2, wherein
the restriction determination threshold is a value corresponding to the coupling coefficient such that the output voltage does not exceed the guaranteed operating voltage of the processor when the current consumption of the processor increases or decreases the most when the low voltage value is set.

4. The electronic control device according to claim 1, wherein
the processor is further configured to
change the voltage setting value and a frequency setting value, which is a setting value of a switching frequency, as setting values of the control unit, and
compare the coupling coefficient with a frequency change threshold that is lower than the voltage change threshold, and when the coupling coefficient is equal to or less than the frequency change threshold, set the low voltage value as the voltage setting value, and set a high frequency that is higher than a reference frequency that is set when the coupling coefficient exceeds the frequency change threshold as the frequency setting value.

5. The electronic control device according to claim 4, wherein
the processor is further configured to compare the coupling coefficient with the restriction determination threshold that is lower than the frequency change threshold, and when the coupling coefficient is equal to or less than the restriction determination threshold, limit an operation of the processor so that a fluctuation range of the current consumption of the processor is smaller than when the low voltage value and the high frequency are set.

6. The electronic control device according to claim 4, wherein
the frequency change threshold is a value corresponding to the coupling coefficient that prevents the output voltage from falling below a lower limit of the guaranteed operating voltage of the processor when the current consumption of the processor increases the most when the low voltage value is set.

7. The electronic control device according to claim 5, wherein
the restriction determination threshold is a value corresponding to the coupling coefficient that prevents the output voltage from exceeding the guaranteed operating voltage of the processor when the current consumption of the processor increases or decreases the most in the low voltage value and high frequency state.

8. An electronic control device, comprising:
a multi-phase power supply having a plurality of phases each including a driver and an inductor, the inductor of each phase being configured by a coupled inductor;
a processor configured to receive power from the multi-phase power supply and operate;
a control unit configured to control an on/off of the driver at a predetermined switching frequency so that an output of the multi-phase power supply becomes a predetermined output voltage; and
a setting change unit configured to change at least a voltage setting value, which is a setting value of the output voltage, among the setting values of the control unit, based on a coupling coefficient of the coupled inductor; wherein the setting change unit compares the coupling coefficient with a voltage change threshold, and when the coupling coefficient is equal to or less than the voltage change threshold, sets the voltage setting value to a low voltage value that is lower than a reference voltage value that is set when the coupling coefficient exceeds the voltage change threshold, and
the voltage change threshold is a value corresponding to the coupling coefficient that prevents the output voltage from exceeding an upper limit of a guaranteed operating voltage of the processor when the current consumption of the processor decreases the most.

9. The electronic control device according to claim 8, wherein
the setting change unit compares the coupling coefficient with a restriction determination threshold that is lower than the voltage change threshold, and when the coupling coefficient is equal to or less than the restriction determination threshold, limits an operation of the processor so that a fluctuation range of the current consumption of the processor is smaller than when the low voltage value is set.

10. The electronic control device according to claim 9, wherein
the restriction determination threshold is a value corresponding to the coupling coefficient such that the output voltage does not exceed the guaranteed operating voltage of the processor when the current consumption of the processor increases or decreases the most when the low voltage value is set.

11. The electronic control device according to claim 8, wherein
the setting change unit changes the voltage setting value and a frequency setting value, which is a setting value of a switching frequency, as setting values of the control unit, and
the setting change unit compares the coupling coefficient with a frequency change threshold that is lower than the voltage change threshold, and when the coupling coefficient is equal to or less than the frequency change threshold, sets the low voltage value as the voltage setting value, and sets a high frequency that is higher than a reference frequency that is set when the coupling coefficient exceeds the frequency change threshold as the frequency setting value.

12. The electronic control device according to claim 11, wherein
the setting change unit compares the coupling coefficient with the restriction determination threshold that is lower than the frequency change threshold, and when the coupling coefficient is equal to or less than the restriction determination threshold, limits an operation of the processor so that a fluctuation range of the current consumption of the processor is smaller than when the low voltage value and the high frequency are set.

13. The electronic control device according to claim 11, wherein
the frequency change threshold is a value corresponding to the coupling coefficient that prevents the output voltage from falling below a lower limit of the guaranteed operating voltage of the processor when the current consumption of the processor increases the most when the low voltage value is set.

14. The electronic control device according to claim 12, wherein
the restriction determination threshold is a value corresponding to the coupling coefficient that prevents the output voltage from exceeding the guaranteed operating voltage of the processor when the current consumption of the processor increases or decreases the most in the low voltage value and high frequency state.

15. The electronic control device according to claim 8, wherein the setting change unit is provided within the processor.
